(19) United States
(12) Patent Application Publication
(10) Pub. No.: US 2022/0255182 A1
(43) Pub. Date: Aug. 11, 2022

(54) POWER SUPPLY DEVICE, ELECTRIC VEHICLE PROVIDED WITH THIS POWER SUPPLY DEVICE, AND ELECTRICITY STORAGE DEVICE

(71) Applicant: SANYO Electric Co., Ltd., Osaka (JP)

(72) Inventors: NAO KOGAMI, Hyogo (JP); HIROYUKI TAKAHASHI, Hyogo (JP)

(21) Appl. No.: 17/619,457

(22) PCT Filed: Jun. 15, 2020
(86) PCT No.: PCT/JP2020/023445

§ 371 Date: Dec. 15, 2021

(30) Foreign Application Priority Data
Jun. 28, 2019 (JP) 2019-122221

(51) Int. Cl. H01M 50/293; H01M 50/209; H01M 10/04; H01M 10/658; B60L 50/64

(52) U.S. Cl. CPC H01M 50/293; H01M 50/209; B60K 6/28; H01M 10/658; B60L 50/64; H01M 10/0481

(57) ABSTRACT

End plates are disposed on respective end faces of a battery block formed by stacking a plurality of battery cells in a thickness with separator interposed between corresponding battery cells, and the end plates paired are coupled by a binding bar to fix the battery block in a compressed state. Separator includes heat insulating layer, elastic layer that absorbs expansion of battery cells, and stopper that limits a compression thickness of elastic layer, and stopper has higher rigidity than elastic layer.

### TECHNICAL FIELD

The present invention relates to a power supply device with a large number of battery cells stacked, and an electric vehicle and a power storage device that include the power supply device.

### BACKGROUND ART

A power supply device with a large number of battery cells stacked is suitable for a power supply that is mounted on an electric vehicle and supplies electric power to a motor that drives the vehicle, a power supply that is charged with natural energy, such as a solar battery, or midnight power, and a backup power supply for power failure. The power supply device having this structure includes a separator interposed between corresponding battery cells stacked. The power supply device includes a large number of battery cells stacked with a separator interposed between corresponding battery cells, and the battery cells stacked are fixed in a compressed state to prevent positional displacement due to expansion of the battery cells. To fabricate the structure, the power supply device includes a pair of end plates disposed on respective end faces of a battery block in which the large number of battery cells are stacked, and the pair of end plates is connected by binding bars (see PTL 1).

### CITATION LIST

### Patent Literature

PTL 1: Unexamined Japanese Patent Publication No. 2015-220117

### SUMMARY OF THE INVENTION

### Technical Problem

The power supply device includes the battery block in which the plurality of battery cells are stacked, the pair of end plates disposed on the respective end faces of the battery block, and handlebars that couple the end plates while the battery block is held in a compressed state under a considerably strong pressure applied from the respective end faces. The power supply device strongly presses and fixes the battery cells to prevent malfunction due to relative movement or vibration of the battery cells. When the power supply device uses, for example, a battery cell with a stacked surface having an area of about 100 cm², the end plates is pressed with a strong force of several tons or more and fixed with the binding bars. The power supply device having this structure includes the separator composed of a hard plastic plate that is used to insulate the battery cells stacked adjacent to each other with the separator. The separator made of hard plastic cannot absorb expansion of the battery cells when the battery cells increase in internal pressure and expand. In this state, contact pressure between the corresponding one of the battery cells and the separator rapidly increases, so that an extremely strong force acts on the end plates and the binding bars. This may cause an adverse effect in which the end plates and the handlebars are each required to have a very strong material and shape, thereby increasing weight, size, and material cost of the power supply device.

The power supply device includes the separator provided with an elastic layer that is to be crushed under pressure of the battery cells, so that strong stress acting on the end plates and the handlebars can be reduced when the battery cells each expand due to increase in its internal pressure. In particular, using a rubber-like elastic body for the separator provided with the elastic layer enables absorbing expansion of the battery cells in a preferable manner. Unfortunately, an elastic layer such as a rubber-like elastic body has a disadvantage in that when the elastic layer is pressed at a strong pressure exceeding an elastic limit or is repeatedly pressed at a strong pressure, the elastic layer deteriorates and changes in physical properties to deteriorate characteristics of absorbing expansion of a battery cell.

The present invention has been developed to solve the above disadvantage, and an object of the present invention is to provide a technique capable of absorbing expansion of a battery cell with a separator over a long period of time.

### Solution to Problem

A power supply device according to an aspect of the present invention includes battery block 10 formed by stacking a plurality of battery cells 1 in a thickness direction with separator 2 interposed between corresponding battery cells 1, a pair of end plates 3 disposed on respective end faces of battery block 10, and binding bar 4 coupled to the pair of end plates to fix battery block 10 in a compressed state together with end plates 3. Separator 2 includes heat insulating layer 5, elastic layer 6 that absorbs expansion of battery cells 1, and stopper 7 that limits a compression thickness of elastic layer 6, and stopper 7 has higher rigidity than elastic layer 6.

An electric vehicle according to an aspect of the present invention includes power supply device 100 described above, traction motor 93 that receives electric power from power supply device 100, vehicle body 91 that incorporates power supply device 100 and motor 93, and wheel 97 that is driven by motor 93 to let vehicle body 91 travel.

A power storage device according to an aspect of the present invention includes power supply device 100 described above and power supply controller 88 to control charging and discharging of power supply device 100. Power supply controller 88 enables charging of secondary battery cells 1 with electric power supplied from an outside and controls secondary battery cells 1 to charge.

### Advantageous Effect of Invention

The power supply device described above is capable of absorbing expansion of the battery cells with the separator for a long period of time.

### BRIEF DESCRIPTION OF DRAWINGS

FIG. 1 is a perspective view of a power supply device according to an exemplary embodiment of the present invention.

FIG. 2 is a vertical sectional view of the power supply device illustrated in FIG. 1.

FIG. 3 is a horizontal sectional view of the power supply device illustrated in FIG. 1.

FIG. 4 is a perspective view illustrating a separator and a battery cell.

FIG. 5 is a perspective view illustrating another example of the separator.

FIG. 6 is a schematic side view of the separator illustrated in FIG. 5.

FIG. 7 is a perspective view illustrating another example of the separator.

FIG. 8 is a schematic side view of the separator illustrated in FIG. 7.

FIG. 9 is a perspective view illustrating another example of the separator.

FIG. 10 is a schematic side view of the separator illustrated in FIG. 9.

FIG. 11 is a perspective view illustrating another example of the separator.

FIG. 12 is a schematic side view of the separator illustrated in FIG. 11.

FIG. 13 is a perspective view illustrating another example of the separator.

FIG. 14 is a schematic side view of the separator illustrated in FIG. 13.

FIG. 15 is a perspective view illustrating another example of the separator.

FIG. 16 is a sectional view taken along line A-A and a sectional view taken along line B-B of the separator illustrated in FIG. 15.

FIG. 17 is an enlarged sectional view of a main part, illustrating a state in which a stopper of the separator illustrated in FIG. 4 is pressed by expanding battery cells.

FIG. 18 is a block diagram illustrating an example of a power supply device mounted in a hybrid vehicle that is driven by an engine and a motor.

FIG. 19 is a block diagram illustrating an example of a power supply device mounted in an electric car that is driven only by a motor.

FIG. 20 is a block diagram illustrating an example of the technique applied to a power supply device for power storage.

### DESCRIPTION OF EMBODIMENTS

Hereinafter, the present invention will be described in detail with reference to the drawings. In the following description, terms (e.g., “top”, “bottom”, and other terms including those terms) indicating specific directions or positions are used as necessary; however, the use of those terms is for facilitating the understanding of the invention with reference to the drawings, and the technical scope of the present invention is not limited by the meanings of the terms. Parts denoted by the same reference numerals in a plurality of drawings indicate the identical or equivalent parts or members.

The exemplary embodiments described below are specific examples of the technical idea of the present invention, and the present invention is not limited to the following exemplary embodiments. Unless specifically stated otherwise, the dimensions, materials, shapes, and relative placement, and the like, of the components described below are not intended to limit the scope of the present invention, and are intended to be illustrative. The contents described in one exemplary embodiment and one example are also applicable to other exemplary embodiments and examples. Additionally, sizes, positional relationships, and the like of members illustrated in the drawings may be exaggerated for clarity of description.

A power supply device according to a first exemplary embodiment of the present invention includes a battery block formed by stacking a plurality of battery cells in a thickness with a separator interposed between corresponding battery cells, a pair of end plates disposed on respective end faces of the battery block, and a binding bar coupled to the pair of end plates to fix the battery block in a compressed state together with the end plates. The separator includes a heat insulating layer, an elastic layer that absorbs expansion of the battery cells, and a stopper that limits a compression thickness of the elastic layer, and the stopper has higher rigidity than the elastic layer.

The power supply device described above has an advantage in that the separator includes the heat insulating layer that prevents the battery cell having generated heat from heating the adjacent battery cell, the elastic layer that absorbs expansion of the battery cells, and the stopper that can restrict strong crushing of the elastic layer, whereby deterioration of the elastic layer can be reduced to reduce deterioration in elasticity of the elastic layer, and the separator can absorb expansion of the battery cells without difficulty for a long period of time. The power supply device is also configured such that the stopper reduces deterioration in physical properties of the elastic layer to prevent the elastic layer from being crushed abnormally thinly even when the battery cells increase in internal pressure.

In addition to the above advantage, the power supply device is capable of reducing relative displacement of a position of each of the battery cells, under a condition where the battery cells repeat expansion and contraction, due to the elastic layer of the separator that can absorb the expansion of the battery cells over a long period of time. The relative positional displacement between the adjacent battery cells causes damage to a bus bar made of a metal sheet fixed to an electrode terminal of each of the battery cells and the electrode terminal. The power supply device in which the separator can prevent relative positional displacement of the battery cells that expand due to increase in internal pressure can prevent failure of a connection part between the electrode terminal and the bus bar due to the expansion of the battery cells.

A power supply device according to a second exemplary embodiment of the present invention includes an elastic layer stacked on a heat insulating layer.

A power supply device according to a third exemplary embodiment of the present invention includes a heat insulating layer made of a hybrid material of an inorganic powder and a fibrous reinforcing material.

The power supply device described above has an advantage in that the heat insulating layer is made of the hybrid material of the inorganic powder and the fibrous reinforcing material, and thus the elastic layer can prevent deterioration in physical properties of the heat insulating layer of the hybrid material while excellent heat resistance characteristics of the separator is ensured.

In a power supply device according to a fourth exemplary embodiment of the present invention, an inorganic powder is silica aerogel.

The power supply device described above has an advantage in that the elastic layer is stacked on the heat insulating layer made of the hybrid material of silica aerogel and the fibrous reinforcing material and the stopper prevents the elastic layer from being crushed abnormally thinly, whereby extremely excellent heat insulation characteristics of the elastic layer is ensured over a long period of time, and thus heat conduction between the battery cells can be efficiently blocked. The heat insulating layer of the hybrid material of silica aerogel and the fibrous reinforcing material exhibits extremely excellent heat insulation characteristics due to low thermal conductivity of the inorganic powder of silica aerogel being fine. The silica aerogel is fine particles composed of a skeleton of silicon dioxide (SiO2) and 90% to 98% air. A fiber sheet having gaps filled with the silica aerogel achieves excellent heat insulation characteristics with a thermal conductivity of 0.02 W/m·K due to an extremely high porosity of the silica aerogel. The heat insulating layer of the hybrid material deteriorates in heat insulation characteristics when the silica aerogel of the inorganic powder is broken under pressure. The heat insulating layer layered on the heat insulating layer absorbs expansion of the battery cells to prevent the silica aerogel from being strongly pressed by the expansion of the battery cells. This structure prevents the battery cells expanding from pressing and breaking the silica aerogel, so that the excellent heat insulation characteristics are ensured over a long period of time. The stopper also prevents deterioration in physical properties of the elastic layer, so that the elastic layer is elastically deformed over a long period of time. The elastic layer, which elastically deforms, absorbs the expansion of the battery cells and prevents the silica aerogel from being broken under pressure. The stopper ensures deterioration of the physical properties of the elastic layer over a long period of time, so that the expansion of the battery cells is absorbed by the elastic layer over a long period of time. Thus, the elastic layer protects the silica aerogel to enable reducing deterioration of the heat insulation characteristics due to breakage under pressure.

The power supply device described above causes the elastic layer layered on the heat insulating layer to be thinly deformed to reduce internal stress of the heat insulating layer when the battery cells expand, so that the hybrid material of the heat insulating layer is not required to have physical properties of being elastically deformed under pressure. This brings an advantage in that the heat insulation characteristics of the heat insulating layer can be enhanced by controlling filling of the silica aerogel for the hybrid material to have ideal heat insulating properties.

In a power supply device according to a fifth exemplary embodiment of the present invention, the elastic layer is an elastic body. A power supply device according to a sixth exemplary embodiment of the present invention includes the elastic body that is made of at least one selected from synthetic rubber, thermoplastic elastomer, and foam material.

In a power supply device according to a seventh exemplary embodiment of the present invention, the stopper is made of a hybrid material of an inorganic powder and a fibrous reinforcing material.

The power supply device described above includes the stopper that is made of the hybrid material of the inorganic powder and the fibrous reinforcing material, so that the stopper can have extremely excellent heat insulation characteristics. This structure allows the separator to have excellent heat insulation characteristics over a wide area, so that heat conduction between adjacent battery cells can be efficiently blocked. This achieves an advantage in that induction of thermal runaway of the battery cells is effectively prevented to enable ensuring high safety of the power supply device.

In a power supply device according to an eighth exemplary embodiment of the present invention, the stopper passes through the elastic layer. In a power supply device according to a ninth exemplary embodiment of the present invention, the stopper passes through the heat insulating layer and the elastic layer. In a power supply device according to a tenth exemplary embodiment of the present invention, the stopper is made of a material having a higher Young's modulus than the heat insulating layer and the elastic layer.

A power supply device according to an eleventh exemplary embodiment of the present invention includes the separator provided with a plurality of stoppers.

The power supply device described above enables expansion of the battery cells to be restricted to an ideal shape by the plurality of stoppers adjusted for disposition.

### First Exemplary Embodiment

Hereinafter, a power supply device and an electric vehicle will be more specifically described in detail.

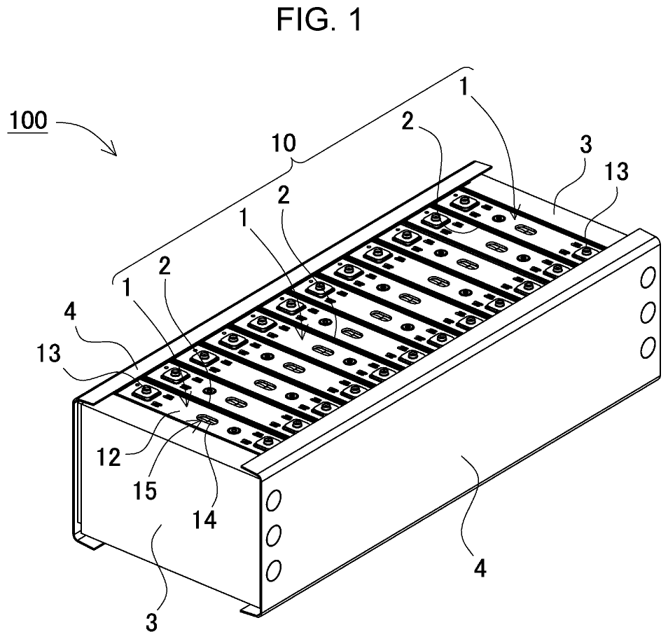

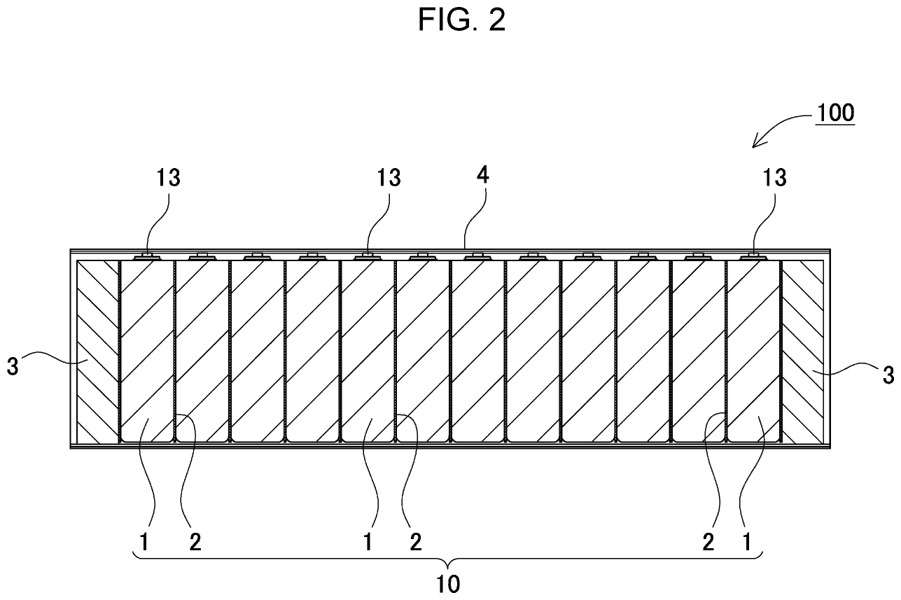

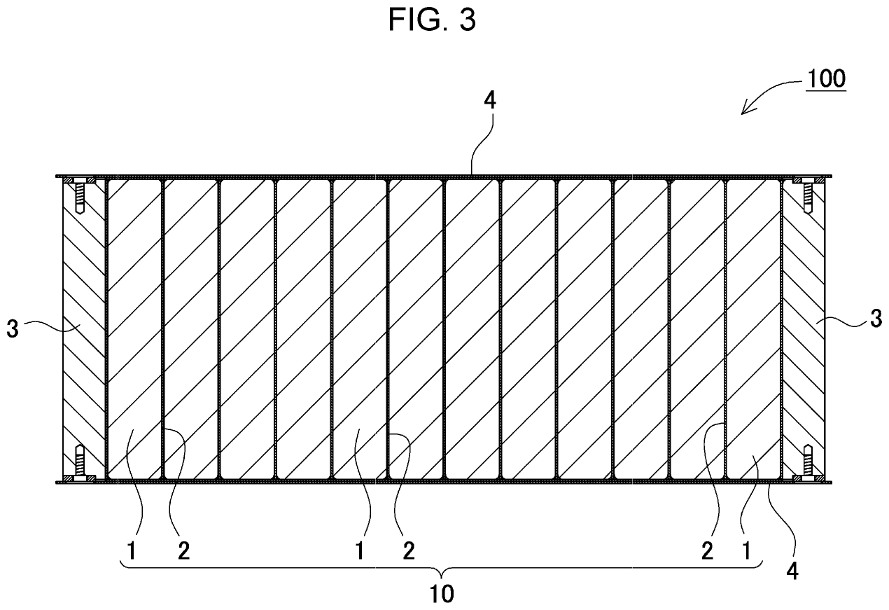

Power supply device 100 illustrated in the perspective view of FIG. 1, the vertical sectional view of FIG. 2, and the horizontal sectional view of FIG. 3 includes battery block 10 in which a plurality of battery cells 1 is stacked in a thickness with separator 2 interposed between corresponding battery cells 1, a pair of end plates 3 disposed on respective end faces of battery block 10, and binding bar 4 that couples the pair of end plates 3 to fix battery block 10 in a compressed state together with end plates 3.

### (Battery Block 10)

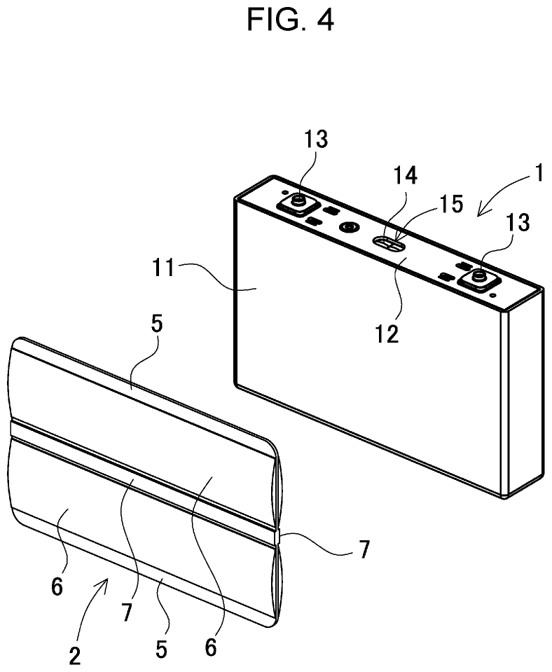

As illustrated in FIG. 4, battery cell 1 of battery block 10 is a prismatic battery cell having a quadrangular outer shape, and includes battery case 11 that has a bottom closed and an opening to which sealing plate 12 is airtightly fixed by laser welding, and thus having an internally sealed structure. Sealing plate 12 is provided with a pair of positive and negative electrode terminals 13 protruding at both ends. Between electrode terminals 13, opening 15 of safety valve 14 is provided. Safety valve 14 opens to release internal gas when internal pressure of battery cell 1 rises to a predetermined value or more. Safety valve 14 prevents a rise in internal pressure of battery cell 1.

### (Battery Cell 1)

Battery cell 1 is a lithium ion secondary battery. Power supply device 100 provided with a lithium ion secondary battery serving as battery cell 1 has an advantage in that charge capacity per volume and weight can be increased. However, battery cell 1 may be any other chargeable battery such as a non-aqueous electrolyte secondary battery other than the lithium ion secondary battery.

### (End Plate 3, Binding Bar 4)

End plate 3 is a metal plate substantially coinciding in outer shape with battery cell 1 and is not deformed by being pressed by battery block 10, and binding bars 4 are coupled to both side edges of end plate 3. Binding bars 4 fix battery block 10 in a compressed state under a predetermined pressure while end plates 3 couple battery cells 1 stacked in a compressed state.

### (Separator 2)

Separator 2 is sandwiched between adjacent battery cells 1, which are stacked, to absorb expansion of battery cells 1 and insulate adjacent battery cells 1, and further blocks heat conduction between adjacent battery cells 1. Battery block 10 includes bus bars (not illustrated) fixed to electrode terminals 13 of adjacent battery cells 1 to connect battery cells 1 in series or in parallel. Battery cells 1 connected in series cause a potential difference to be generated between battery cases 11, and thus are stacked while being insulated by separator 2. Although battery cells 1 connected in parallel cause no potential difference to be generated between battery cases 11, battery cells 1 are stacked while being thermally insulated by separator 2 to prevent induction of thermal runaway.

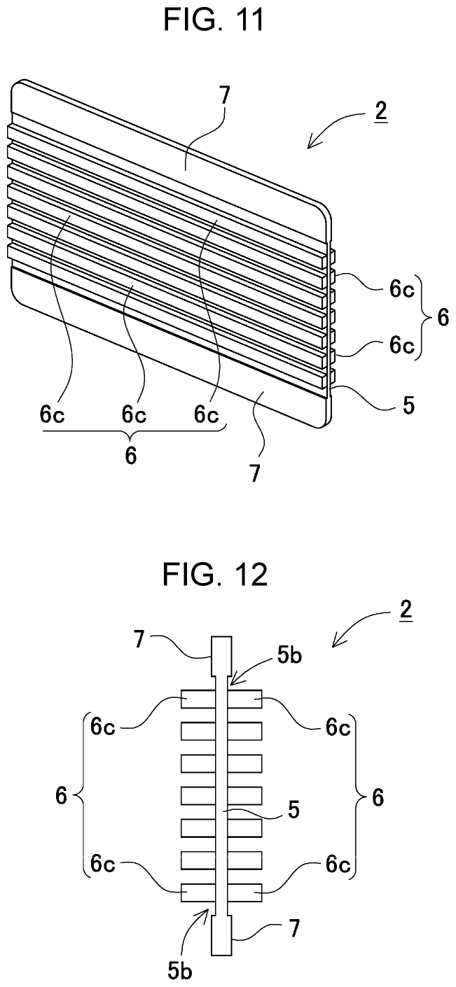

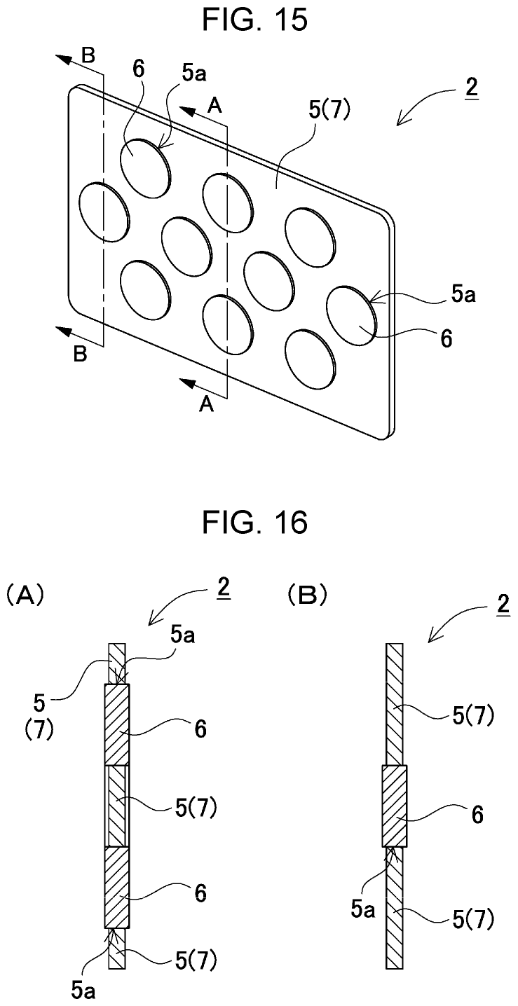

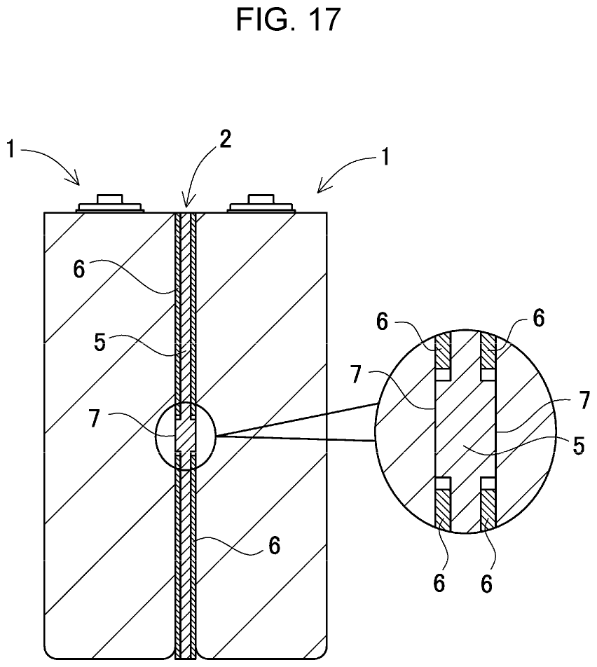

Separator 2 of FIGS. 4 to 14 includes elastic layer 6 layered on a surface of heat insulating layer 5. Separator 2 of FIGS. 15 and 16 includes heat insulating layer 5 provided with through-hole 5a, and elastic layer 6 is inserted into through-hole 5a. Separator 2 also includes stopper 7 that limits compressive thickness of elastic layer 6. Stopper 7 has a higher Young's modulus than elastic layer 6, and suppresses expansion of the battery cell to prevent elastic layer 6 from being crushed thinner than its elastic limit and losing its recoverability. As heat insulating layer 5, a hybrid material of an inorganic powder and a fibrous reinforcing material is suitable. The hybrid material preferably contains silica aerogel as the inorganic powder. This heat insulating layer 5 is filled with the inorganic powder such as the silica aerogel having extremely low thermal conductivity in a gap between fibers.

Elastic layer 6 absorbs expansion of battery cell 1 and further presses a case surface of battery cell 1 to reduce contact pressure at which the case surface of battery cell 1 expanding presses heat insulating layer 5. Although the hybrid material of the silica aerogel and the fibrous reinforcing material deteriorates in heat insulation characteristics when the silica aerogel is compressed and broken, separator 2 including elastic layer 6 capable of reducing the contact pressure prevents breakage of the silica aerogel and maintains excellent heat insulation characteristics.

Heat insulating layer 5 made of the hybrid material includes silica aerogel having a nano-sized porous structure and a fiber sheet. This heat insulating layer 5 is manufactured by impregnating fibers with a gel raw material of silica aerogel. After the fiber sheet is impregnated with the silica aerogel, the fibers are stacked to cause the gel raw material to react to form a wet gel. Then, a surface of the wet gel is hydrophobized and dried with hot air to manufacture heat insulating layer 5. The fibers of the fiber sheet are polyethylene terephthalate (PET). However, as the fibers of the fiber sheet, inorganic fibers such as oxidized acrylic fibers subjected to flame-retardant treatment and glass wool can also be used.

The fiber sheet of heat insulating layer 5 preferably has a fiber diameter of 0.1 μm to 30 μm. Reducing the fiber diameter of the fiber sheet to smaller than 30 μm reduces heat conduction through the fibers to enable improving heat insulation characteristics of heat insulating layer 5. The silica aerogel is inorganic fine particles composed of 90% to 98% air, and has fine pores between skeletons formed by clusters in which nano-order spherical bodies are bonded, thereby forming a three-dimensional fine porous structure.

Heat insulating layer 5 composed of the fiber sheet and the silica aerogel is thin and exhibits excellent heat insulation characteristics. Heat insulating layer 5 is set to a thickness capable of preventing induction of thermal runaway of battery cell 1 in consideration of energy generated by thermal runaway of battery cell 1. The energy generated by the thermal runaway of battery cell 1 increases as charge capacity of battery cell 1 increases. Thus, the thickness of heat insulating layer 5 is set to an optimum value in consideration of the charge capacity of battery cell 1. For example, a power supply device using a lithium ion secondary battery having a charge capacity of 5 Ah to 20 Ah as battery cell 1 includes heat insulating layer 5 having a thickness set to 0.5 mm to 2 mm, optimally to about 1 mm to 1.5 mm. However, the present invention does not specify the thickness of the elastic sheet within the above range, and the thickness of heat insulating layer 5 is set to an optimum value in consideration of heat insulation characteristics of a combination of the fiber sheet and the silica aerogel for the thermal runaway and heat insulation characteristics required for preventing induction of the thermal runaway of battery cell 1.

Separator 2 illustrated in FIGS. 4 to 14 includes elastic layers 6 layered on respective surfaces of heat insulating layer 5, and separator 2 illustrated in FIGS. 15 and 16 includes elastic layers 6 disposed passing through heat insulating layer 5. As separator 2 increases in thickness, battery block 10 increases in size when separator 2 is stacked between corresponding battery cells 1. Battery block 10 is required to be downsized, so that separator 2 is required to achieve heat insulation characteristics at a minimum thickness. This is because power supply device 100 is required to be increased in charge capacity per volume. Thus, it is important for power supply device 100 to prevent induction of thermal runaway of battery cell 1 using separator 2 reduced in thickness entirely to downsize battery block 10 and increase the charge capacity. For this reason, elastic layer 6 is set to, for example, 0.2 mm or more and 2 mm or less, more preferably to 0.3 mm to 1 mm or less to suppress an increase in compressive stress due to expansion of battery cell 1. Elastic layer 6 preferably reduces compressive stress when battery cell 1 expands, while being reduced in thickness to less than that of heat insulating layer 5.

Elastic layer 6 is a non-foamed elastic body. Besides the non-foamed elastic body, an elastic body of a thermoplastic elastomer or a foam material may be used. An elastic protrusion made of the non-foamed elastic body has incompressibility that allows volume to hardly change due to compression and thus pushes out the elastic body compressed and crushed to a deformation space, and then the elastic protrusion is deformed thinly. The elastic body of elastic layer 6 is preferably a synthetic rubber, a thermoplastic elastomer, or a foam material. The synthetic rubber suitably has a heat resistance limit temperature of 100° C. or higher. Available examples of the synthetic rubber include silicone rubber, fluororubber, urethane rubber, isoprene rubber, styrene butadiene rubber, butadiene rubber, chloroprene rubber, nitrile rubber, hydrogenated nitrile rubber, polyisobutylene rubber, ethylene propylene rubber, ethylene vinyl acetate copolymer rubber, chlorosulfonated polyethylene rubber, acrylic rubber, epichlorohydrin rubber, thermoplastic olefin rubber, ethylene propylene diene rubber, butyl rubber, polyether rubber, and the like.

In particular, the fluororubber and the silicone rubber have a considerably high heat resistance limit temperature of 230° C., and are characterized by being capable of retaining rubber-like elasticity while being heated by a battery cell at high temperature and of stably absorbing expansion of the battery cell that generates heat at high temperature. Additionally, the acrylic rubber has a heat resistance limit temperature of 160° C., and the hydrogenated nitrile rubber, the ethylene propylene rubber, and the butyl rubber each have a heat resistance limit temperature of 140° C., the heat resistance limit temperatures being 100° C. or higher, so that expansion of even the battery cell generating heat at high temperature can be stably absorbed.

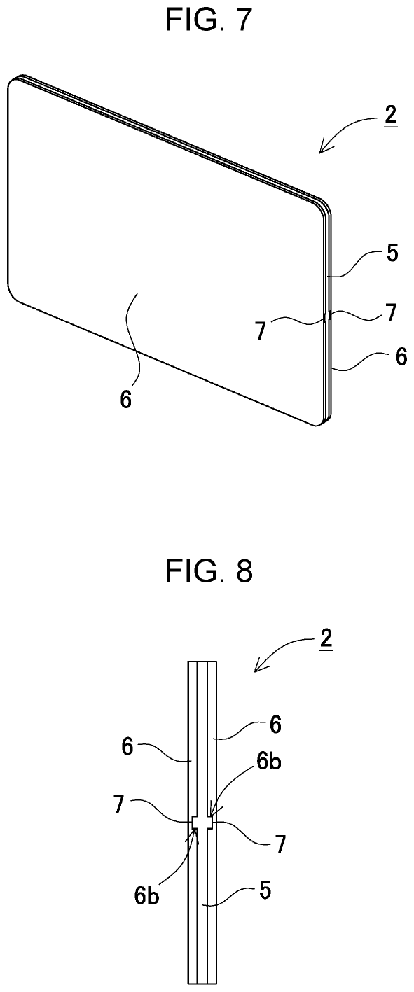

Stopper 7 is disposed in a gap between adjacent battery cells 1. Stopper 7 is disposed with both end faces opposite to the respective surfaces of the battery cells. Both the end faces of stopper 7 are in direct contact with the respective surfaces of the battery cells expanding or in contact with the respective surfaces of the battery cells with elastic layers 6 interposed therebetween to limit a thickness at which elastic layers 6 are crushed. Although elastic layer 6 is elastically deformed thinly by being pressed by battery cell 1 expanding, stopper 7 limits a thickness of elastic layer 6 crushed. As illustrated in FIGS. 7 and 8, stopper 7 in contact with the surface of the battery cell with elastic layer 6 interposed therebetween limits expansion of battery cell 1 by pressing the surface of the battery cell with elastic layer 6 thinly crushed and interposed therebetween.

Stopper 7 limits the thickness at which elastic layer 6 is crushed by battery cell 1 expanding, so that stopper 7 has higher rigidity than elastic layer 6 and is preferably a rigid body having a high Young's modulus that is hardly compressed when being pressed by battery cell 1 expanding. Stopper 7 does not necessarily need to be a rigid body that completely prevents expansion of battery cell 1. Stopper 7 having a higher Young's modulus than elastic layer 6 restricts expansion of battery cell 1 more strongly than elastic layer 6 while having both end faces in contact with the respective facing surfaces of battery cells 1, and suppresses crushing thinly elastic layer 6 to protect elastic layer 6.

Stopper 7 preferably is made of a hybrid material of an inorganic powder such as silica aerogel and a fibrous reinforcing material, and has an integral structure with heat insulating layer 5. However, stopper 7 may be made of a hybrid material having a higher Young's modulus than heat insulating layer 5. Although not illustrated, stopper 7 may be made of an insulating material such as hard plastic. Stopper 7 passes through separator 2 and has both end faces disposed in a gap between battery cells 1 facing each other. Separator 2 including heat insulating layer 5 and stopper 7, which are each made of a hybrid material, has the whole surface made of the hybrid material having excellent heat insulation characteristics and thus can thermally insulate adjacent battery cells 1 from each other in an ideal state. The hybrid material can be increased in Young's modulus by increasing packing density of the inorganic powder. The hybrid material constituting the integral structure of heat insulating layer 5 and stopper 7 is increased in Young's modulus by increasing the packing density of the inorganic powder such as silica aerogel to have the Young's modulus capable of restricting expansion of battery cell 1. Stopper 7 having the integral structure with heat insulating layer 5 is disposed between elastic layers 6 disposed vertically as illustrated in FIG. 4, or is guided and disposed in recess 6b of elastic layer 6 layered on the surface of heat insulating layer 5 as illustrated in FIG. 8. As illustrated in FIG. 16, separator 2 may include elastic layer 6 disposed in through-hole 5a provided in heat insulating layer 5 serving also as stopper 7.

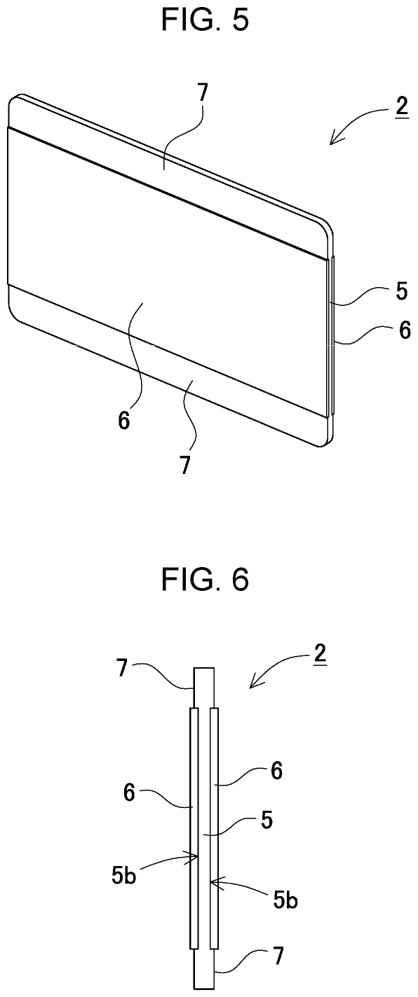

Separator 2 of FIGS. 4 to 14 is provided with stopper 7 extending in a width. Separator 2 of FIGS. 4 and 8 includes stopper 7 disposed at a vertically central part, separator 2 of FIGS. 5, 6, and 9 to 14 includes stoppers 7 disposed along its upper and lower edge parts, and the separator of FIG. 15 includes heat insulating layer 5 serving also as stopper 7 and elastic layer 6 guided into through-hole 5a provided in heat insulating layer 5. Stopper 7 restricts expansion of battery cells 1 with both end faces of stopper 7 in contact with respective surfaces of adjacent battery cells 1 as illustrated in the sectional view of FIG. 17 while battery cells 1 expand. Separator 2 with stopper 7 disposed at the vertically central part restricts expansion of battery cell 1 at its vertically central part to prevent elastic layer 6 from being crushed thinly. When a battery cell rises in internal pressure and expands in a power supply device including a separator provided with no stopper, a central part of a case expands largest, and thus an elastic layer is crushed most thinly at the central part. As illustrated in FIGS. 4, 7, and 8, separator 2 provided at its central part with stopper 7 restricts elastic layer 6 from being crushed thinly in a region where battery cell 1 most expands, so that a region where elasticity of elastic layer 6 is particularly likely to be lost can be protected. Separator 2 provided along its upper edge with stopper 7 restricts expansion of an upper part of battery cell 1. Battery cell 1 includes sealing plate 12 welded to an upper part of battery case 11, so that deformation of the upper part causes damage to a coupling part between battery case 11 and sealing plate 12. Separator 2 provided along its upper edge with stopper 7 can prevent damage to battery case 11 by preventing deformation of an upper edge part of battery cell 1 with stopper 7. Separator 2 provided along its upper and lower edges with stoppers 7 has an advantage in that deformation of upper and lower edges of battery cell 1 can be prevented to prevent damage to the upper and lower edges of battery cell 1.

Separator 2 of FIGS. 5 and 6 has an integral structure of heat insulating layer 5 and stopper 7, being made of a hybrid material, in which heat insulating layer 5 has upper and lower edge parts increased in thickness and also serving as stoppers 7, and elastic layer 6 is layered in recess 5b provided between the upper and lower edge parts. This separator 2 is stacked between adjacent battery cells 1, and when battery cells 1 do not expand, a surface of elastic layer 6 is in close contact with a surface of battery cell 1, and stopper 7 is at a position not in contact with the surface of the battery cell. When battery cell 1 expands to crush elastic layer 6, the surface of the battery cell comes into contact with stopper 7 to restrict the expansion.

Separator 2 of FIGS. 7 and 8 also has an integral structure of heat insulating layer 5 and stopper 7, being made of a hybrid material, in which heat insulating layer 5 has a vertically central part increased in thickness and also serving as stopper 7. This separator 2 includes elastic layer 6 layered on the entire surface of heat insulating layer 5, and recess 6b into which stopper 7 is guided and that is provided in elastic layer 6 to allow separator 2 to have a smooth surface. Stopper 7 has both end faces on which thin elastic layers 6 are layered and that are each in contact with a surface of the battery cell with elastic layer 6 interposed therebetween. This separator 2 is stacked between adjacent battery cells 1, and when battery cells 1 do not expand, the entire surface of elastic layer 6 is in close contact with the surface of battery cell 1. When battery cells 1 expand and thinly crush elastic layer 6, stopper 7 presses the surface of the battery cell with elastic layer 6 interposed therebetween and thinly crushed, thereby restricting the expansion of battery cells 1. This separator 2 includes stopper 7 that presses the surface of the battery cell with elastic layer 6 interposed therebetween. Stopper 7 made of the hybrid material and pressed against the surface of the battery cell with elastic layer 6 interposed therebetween has an advantage in that deterioration in heat insulation characteristics due to breakage of silica aerogel in elastic layer 6 can be reduced as compared with the hybrid material directly pressing the surface of the battery cell.

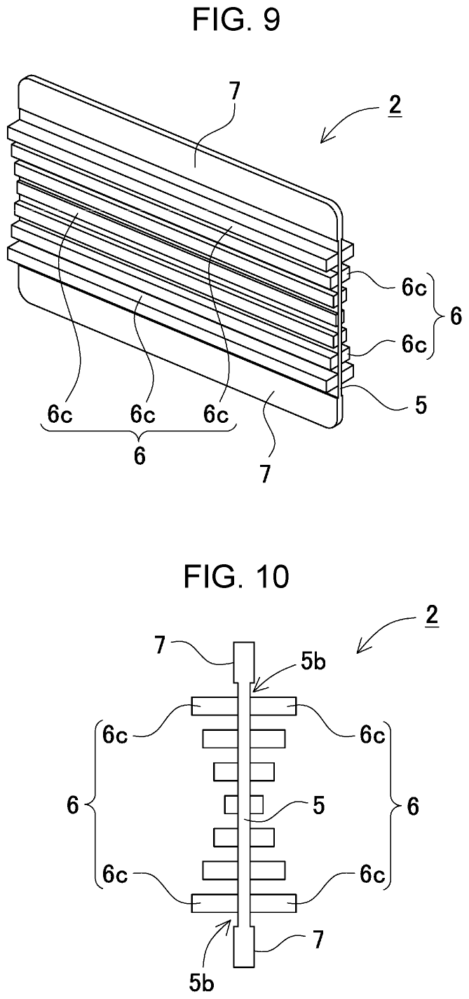

Separator 2 of FIGS. 9 to 12 also has an integral structure of heat insulating layer 5 and stopper 7, being made of a hybrid material, in which heat insulating layer 5 has upper and lower edge parts increased in thickness and also serving as stoppers 7, and elastic layer 6 including a plurality of rows of protrusions 6c extending in the width is layered in recess 5b provided between the upper and lower edge parts. The separator of FIG. 9 includes elastic layer 6 disposed at a vertically central part with protrusions 6c reduced in height, and elastic layer 6 disposed toward the upper edge and that toward the lower edge with protrusions 6c increased in height. Separator 2 of FIG. 11 includes elastic layer 6 in which the plurality of rows of protrusions 6c is equal in height and width. These separators 2 are each stacked between adjacent battery cells 1, and when battery cells 1 do not expand, a surface of elastic layer 6 is in close contact with a surface of battery cell 1, and stopper 7 is not in contact with the surface of battery cell 1. However, when battery cells 1 do not expand, separator 2 of FIG. 9 can be disposed such that elastic layers 6 with protrusions 6c disposed in the upper and lower parts are brought into close contact with the surface of battery cell 1, and protrusions 6c at the central part are not brought into close contact with the surface of battery cell 1. When battery cells 1 expand and crush elastic layer 6, the surface of the battery cell comes into contact with stopper 7 to restrict the expansion. Then, separator 2 of FIGS. 9 and 10 allows the surface of the battery cell to expand and protrude at the central part, and separator 2 of FIG. 11 allows the surface of the battery cell to expand in a state approximating a plane. Elastic layer 6 including protrusions 6c is pressed by the surface of the battery cell expanding and is crushed thinly. Then elastic layer 6 is crushed to have a wide lateral width, and thus is deformed more smoothly to absorb the expansion of battery cell 1.

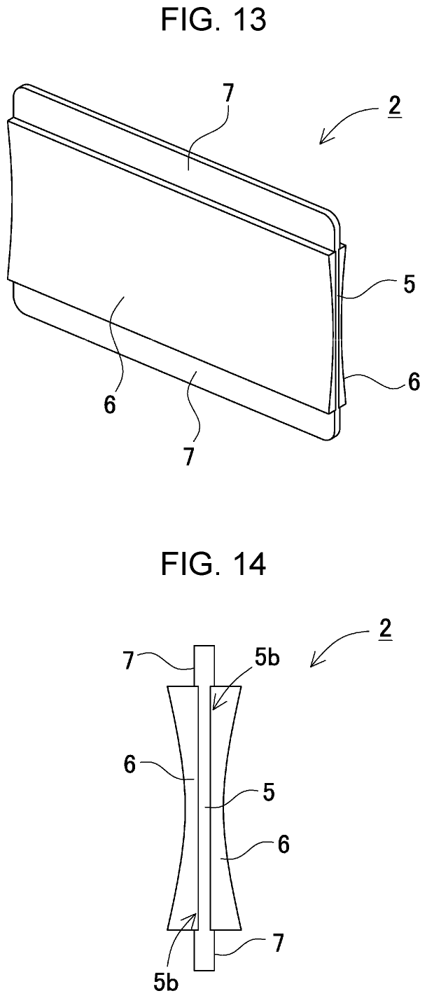

Separator 2 of FIGS. 13 and 14 has an integral structure of heat insulating layer 5 and stopper 7, being made of a hybrid material, in which heat insulating layer 5 has upper and lower edge parts increased in thickness and also serving as stoppers 7, and elastic layer 6 increasing in thickness toward its upper and lower edge parts is layered in recess 5b provided between the upper and lower edge parts. This separator 2 is stacked between adjacent battery cells 1, and when battery cells 1 do not expand, a part of a surface of elastic layer 6 is in close contact with a surface of battery cell 1, and stopper 7 is not in contact with the surface of the battery cell. However, this separator 2 can bring the entire surface of elastic layer 6 into close contact with the surface of the battery cell when battery cell 1 does not expand. When battery cell 1 expands to crush elastic layer 6, the surface of the battery cell comes into contact with stopper 7 to restrict the expansion, but the central part of the battery cell expands into a shape highly protruding.

Separator 2 of FIGS. 15 and 16 has an integral structure of heat insulating layer 5 and stopper 7, being made of a hybrid material, in which heat insulating layer 5 entirely also serves as stopper 7. Heat insulating layer 5 also serving as stopper 7 is provided with through-hole 5a into which elastic layer 6 is guided. Heat insulating layer 5 also serving as stopper 7 is provided with a plurality of through-holes 5a into each of which elastic layer 6 is guided. This separator 2 allows heat insulating layer 5 to also serve as stopper 7 by providing through-hole 5a in a hybrid material equal in thickness as a whole, so that the hybrid material can be easily manufactured. This separator 2 can efficiently absorb expansion of battery cell 1 by increasing a total area of through-holes 5a to increase an area of elastic layer 6, and conversely, separator 2 can increase its heat insulation characteristics by reducing the total area of through-holes 5a and increasing an area of heat insulating layer 5. Elastic layer 6 guided into through-hole 5a is thicker than heat insulating layer 5 also serving as stopper 7, and both surfaces of elastic layer 6 are in close contact with the surface of the battery cell when battery cell 1 does not expand. When battery cell 1 expands to crush elastic layer 6, elastic layer 6 also serving as stopper 7 comes into contact with the surface of the battery cell to restrict the expansion of battery cell 1.

Elastic layer 6, heat insulating layer 5, and stopper 7 are bonded to each other with an adhesive layer or a bonding layer interposed therebetween, and are layered at a fixed position. Separator 2 and battery cell 1 are also bonded to each other with an adhesive or a bonding layer interposed therebetween and are each disposed at a fixed position. Separator 2 can also be disposed at a fixed position of a battery holder (not illustrated) that disposes each of battery cells 1 at a fixed position in a fitting structure.

Power supply device 100 described above includes battery cell 1 that is a prismatic battery cell having a charge capacity of 6 Ah to 80 Ah, heat insulating layer 5 of separator 2, being a “NASBIS (registered trademark) available from Panasonic Corporation” having a thickness of 1 mm in which a fiber sheet is filled with silica aerogel, elastic layer 6 layered on both surfaces of heat insulating layer 5, being made of silicon rubber and having a thickness of 0.5 mm, and stopper 7 having a height set to 1.5 mm, so that deterioration of elastic layer 6 due to an increase in internal pressure of battery cell 1 can be prevented.

The power supply device described above can be used as an automotive power supply that supplies electric power to a motor used to drive an electric vehicle. Available examples of an electric vehicle equipped with the power supply device include a hybrid car or a plug-in hybrid car that is driven by an engine and a motor, and an electric vehicle such as an electric car that is driven only by a motor, and the power supply device can be used as a power supply for any of these vehicles. Power supply device 100 having high capacity and high output to acquire electric power for driving a vehicle will be described below, for example. Power supply device 100 includes a large number of the above-described power supply devices connected in series or parallel, as well as a necessary controlling circuit.

### (Power Supply Device for Hybrid Vehicle)

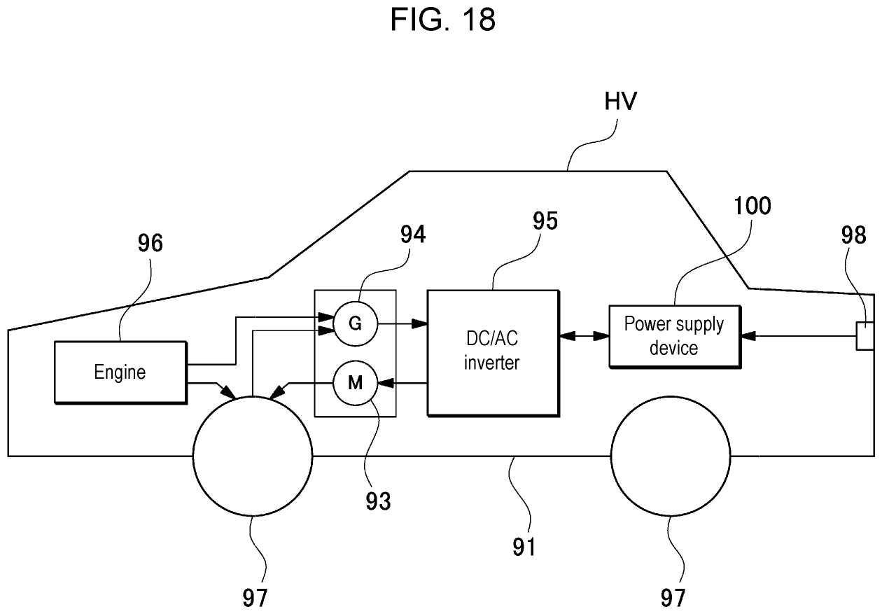

FIG. 18 illustrates an example of a power supply device mounted on a hybrid car that is driven by both an engine and a motor. Vehicle HV equipped with the power supply device illustrated in this drawing includes vehicle body 91, engine 96 and traction motor 93 to let vehicle body 91 travel, wheels 97 that are driven by engine 96 and traction motor 93, power supply device 100 to supply motor 93 with electric power, and generator 94 to charge batteries of power supply device 100. Power supply device 100 is connected to motor 93 and generator 94 via DC/AC inverter 95. Vehicle HV travels by both motor 93 and engine 96 while charging and discharging the battery of power supply device 100. Motor 93 is driven in a region where the engine efficiency is low, for example, during acceleration or low-speed travel, and causes the vehicle to travel. Motor 93 is driven by electric power supplied from power supply device 100. Generator 94 is driven by engine 96 or regenerative braking when the vehicle is braked, to charge the battery of power supply device 100. As illustrated in FIG. 18, vehicle HV may include charging plug 98 to charge power supply device 100. Connecting charging plug 98 to an external power supply enables charging power supply device 100.

### (Power Supply Device for Electric Car)

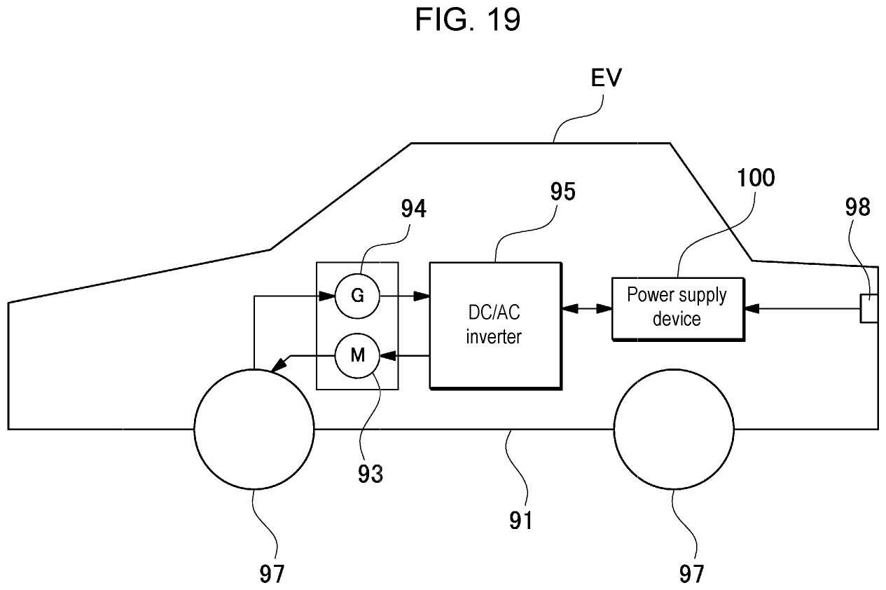

FIG. 19 illustrates an example of a power supply device mounted on an electric car that is driven only by a motor. Vehicle EV equipped with the power supply device illustrated in this figure includes vehicle body 91, traction motor 93 to let vehicle body 91 travel, wheels 97 that are driven by motor 93, power supply device 100 to supply motor 93 with electric power, and generator 94 to charge batteries of power supply device 100. Power supply device 100 is connected to motor 93 and generator 94 via DC/AC inverter 95. Motor 93 is driven by electric power supplied from power supply device 100. Generator 94 is driven by energy produced through regenerative braking of vehicle EV to charge the batteries of power supply device 100. Vehicle EV includes charging plug 98. Connecting charging plug 98 to an external power supply enables charging power supply device 100.

### (Power Supply Device for Power Storage Device)

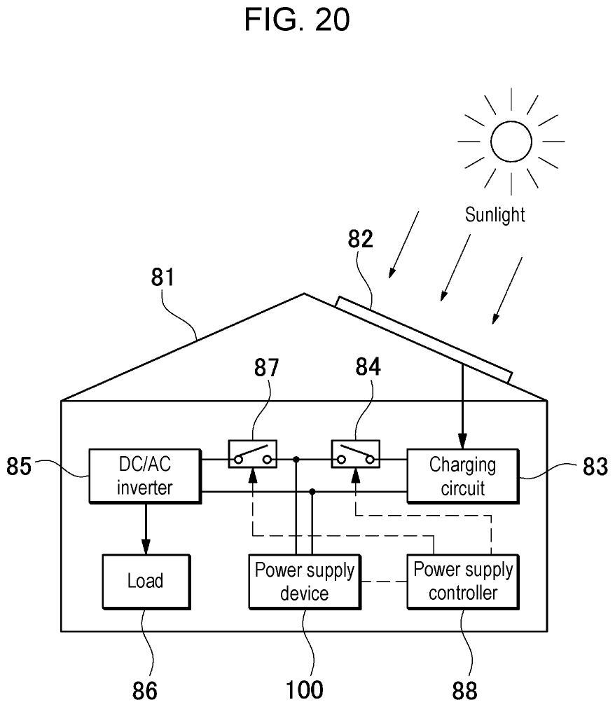

The present invention does not limit a use of the power supply device to a power supply of a motor that causes a vehicle to travel. The power supply device according to the exemplary embodiment can be used as a power supply for a power storage device that stores electricity by charging a battery with electric power generated by photovoltaic power generation, wind power generation, or other methods. FIG. 20 illustrates a power storage device that stores electricity by charging batteries of power supply device 100 with solar battery 82.

The power storage device illustrated in FIG. 20 charges the batteries of power supply device 100 with electric power generated by solar battery 82 that is disposed, for example, on a roof or a rooftop of building 81 such as a house or a factory. The power storage device charges the batteries of power supply device 100 through charging circuit 83 with solar battery 82 serving as a charging power supply, and then supplies electric power to load 86 via DC/AC inverter 85. Thus, the power storage device has a charge mode and a discharge mode. The power storage device illustrated in the drawing includes DC/AC inverter 85 and charging circuit 83 that are connected to power supply device 100 via discharging switch 87 and charging switch 84, respectively. Discharging switch 87 and charging switch 84 are turned on and off by power supply controller 88 of the power storage device. In the charge mode, power supply controller 88 turns on charging switch 84 and turns off discharging switch 87 to allow charging from charging circuit 83 to power supply device 100. When charging is completed and the batteries are fully charged or when the batteries are charged to a predetermined level or higher for capacity, power supply controller 88 turns off charging switch 84 and turns on discharging switch 87 to switch to the discharge mode and permits power supply device 100 to discharge electricity into load 86. When needed, the power supply controller can supply electricity to load 86 and charge power supply device 100 simultaneously by turning charging switch 84 and discharging switch 87 on.

Although not illustrated, the power supply device can also be used as a power supply of a power storage device that stores electricity by charging a battery using midnight power at night. The power supply device charged with the midnight power can limit the peak power during the daytime to a small value by charging with the midnight power that is the surplus power of the power plant, and by output of the power during the daytime when the power load increases. The power supply device can also be used as a power supply that is charged with both output power of a solar battery and the midnight power. This power supply device can efficiently store electricity using both electric power generated by the solar battery and the midnight power in consideration of weather and power consumption.

The power storage device described above can be suitably used for the following applications: a backup power supply device mountable in a rack of a computer server; a backup power supply device used for radio base stations of cellular phones; a power supply for storage used at home or in a factory; a power storage device combined with a solar battery, such as a power supply for street lights; and a backup power supply for traffic lights or traffic displays for roads.

### INDUSTRIAL APPLICABILITY

The power supply device according to the present invention is suitably used as a large current power supply used for a power supply of a motor for driving a hybrid car, a fuel cell car, an electric car, or an electric vehicle such as an electric motorcycle, for example. Examples of the power supply device according to the present invention include a power supply device for a plug-in hybrid electric car and a hybrid electric car, being capable of switching a traveling mode between an EV traveling mode and an HEV traveling mode, and a power supply device for an electric car. The power supply device can also be appropriately used for the following applications: a backup power supply device mountable in a rack of a computer server; a backup power supply device used for radio base stations of cellular phones; a power supply for storage used at home or in a factory; a power storage device combined with a solar battery, such as a power supply for street lights; and a backup power supply for traffic lights.

### REFERENCE MARKS IN THE DRAWINGS

100 power supply device
1 battery cell
2 separator
3 end plate
4 binding bar
5 heat insulating layer
5a through-hole
5b recess
6 elastic layer
6b recess
6c protrusion
7 stopper
10 battery block
11 battery case
12 sealing plate
13 electrode terminal
14 safety valve
15 opening
81 building
82 solar battery
83 charging circuit
84 charging switch
85 DC/AC inverter
86 load
87 discharging switch
88 power supply controller
91 vehicle body
93 motor
94 generator
95 DC/AC inverter
96 engine
97 wheel
98 charging plug
HV, EV vehicle

1. A power supply device comprising:
a battery block including a plurality of battery cells stacked in a thickness with a separator interposed between corresponding battery cells among the plurality of battery cells;
a pair of end plates disposed on respective end faces of the battery block; and
a binding bar coupled to the pair of end plates to fix the battery block in a compressed state together with the end plates,
the separator including:
a heat insulating layer;
an elastic layer that absorbs expansion of each of the corresponding battery cells; and
a stopper that limits a compression thickness of the elastic layers,
the stopper including a higher rigidity than a rigidity of the elastic layers.

2. The power supply device according to claim 1, wherein
the elastic layer is layered on the heat insulating layer.

3. The power supply device according to claim 1, wherein
the heat insulating layer including a hybrid material of an inorganic powder and a fibrous reinforcing material.

4. The power supply device according to claim 3, wherein
the inorganic powder is silica aerogel.

5. The power supply device according to claim 1, wherein
the elastic layer is an elastic body.

6. The power supply device according to claim 5, wherein
the elastic body including at least one selected from synthetic rubber, thermoplastic elastomer, and foam material.

7. The power supply device according to claim 1, wherein
the stopper including the hybrid material of the inorganic powder and the fibrous reinforcing material.

8. The power supply device according to claim 1, wherein
the stopper passes through the elastic layer.

9. The power supply device according to claim 8, wherein
the stopper passes through the heat insulating layer and the elastic layer.

10. The power supply device according to claim 9, wherein
the stopper including a material including a higher Young's modulus than a higher Young's modulus of the heat insulating layer and the elastic layers.

11. The power supply device according to claim 1, wherein
the separator includes a plurality of stoppers each being the stopper.

12. An electric vehicle comprising:
the power supply device according to claim 1:
a motor for travelling that receives electric power from the power supply device;
a vehicle body equipped with the power supply device and the motor; and
a wheel that is driven by the motor to cause the vehicle body travel.

13. A power storage device comprising:
the power supply device according to claim 1;
a power supply controller to control charging and discharging of the power supply device,
wherein the power supply controller enables charging of the plurality of secondary battery cells with electric power supplied from an outside and causes the plurality of secondary battery cells to charge.
